(19) United States
(12) Patent Application Publication
(10) Pub. No.: US 2007/0263413 A1
(43) Pub. Date: Nov. 15, 2007

(54) Backlit Molding for Rope and Module Lighting

(76) Inventors: Herman Spira, Spring Valley, NY (US); Chaim Henry Rausman, Monsey, NY (US)

Correspondence Address: ISRAEL NISSENBAUM, 1038-56TH ST, BROOKLYN, NY, 11219, US

(21) Appl. No.: 11/556,164

(22) Filed: Nov. 2, 2006

Related U.S. Application Data
(60) Provisional application No. 60/732,936, filed on Nov. 2, 2005.

(51) Int. Cl. F21V 21/00

(52) U.S. Cl. 362/633

(57) ABSTRACT

A decorative molding system that utilizes rope and module LED lighting, optical fibers and other types of elongated lighting sources. The system is designed to be used as a framing molding or lighted trim for doors, windows, floors, ceilings and any other place where traditional wood or metal molding is used. The system is also utilizable as a mounting method for rope or module lighting that is meant to be decorative or utilitarian in nature, such as for lighting stairwells, signs, cubicles, and any other place where continuous rope and module lighting would be of aesthetic or useful nature (such as in fire emergencies).

This application is a non-provisional application claiming the benefit under 35 USC 119e of provisional patent application No. 60/732,936 filed Nov. 2, 2005, the disclosure of which is incorporated herein by reference thereto.

### FIELD OF THE INVENTION

The present invention relates to systems that are designed to hold and display rope lights or LED circuit board lighting modules or fiber optical elements and the like for either decorative or utilitarian purposes and particularly the components needed to hold, mount, and display the rope and module lighting as illuminated framing of doors, windows and the like.

### BACKGROUND OF THE INVENTION

Currently flexible rope lighting elements are commercially available in various diameters. Similarly, modules in the form of connectable of LED containing circuit board members are available for making illuminated strips of varying length. These circuit board members are generally flat and are individually of varying lengths. The boards contain imbedded LEDs and appropriate drivers and connective conductive material and circuitry. Rope lighting consists of lights on a strand which are embedded in a clear or tinted flexible tube or rubber-like extrusion. Both forms of lighting can be displayed or secured thru means of simple brackets or snap-fit trim. Optical fibers are strands through which light is direct and, depending on the structure and configuration lighting, is visible at the ends or through the sides of the fibers.

The vast majority of these securing methods are designed to hold the rope and module lighting with as little interference as possible with the light. They add little to the aesthetic value of the rope and module light and are sometimes meant to be used in conjunction with other forms of decorative trim.

### SUMMARY OF THE INVENTION

It is an object of the present invention to provide a system by which rope, module LED, fiber optical elements and other similar lighting elements can be easily incorporated into moldings and trim.

It is a further object of the present invention to provide a framing lighting system which is aesthetically pleasing, allows multiple options for light placement, and provides easy and ridged installation.

It is yet another object to provide such system for applications including doorways, windows, indoor and outdoor signage illuminated framing, cove lighting and the like, as well as for providing emergency lighting.

These and other objects, features and advantages of the present invention will become more evident from the following discussion and drawings in which:

### SHORT DESCRIPTION OF THE DRAWINGS

FIGS. 1a and 1b are front and rear isometric views of an illuminated frame in accordance with the present invention;

FIGS. 2a and 2b are front and side views of the frame of FIG. 1;

FIG. 3 is an exploded view of the elements of the frame of the prior Figures, with contained moldings and lighting elements;

FIG. 4 is a cross section view of the lighting element retaining molding;

FIG. 5 is a cross section view of the lighting element retaining molding of FIG. 4 with optional mounting elements and inserted rope lights;

FIG. 6 is a cross section view of another embodiment of the light retaining molding.

### DETAILED DESCRIPTION OF THE INVENTION

The present invention comprises a decorative molding system that utilizes rope and module LED lighting, optical fibers and other types of elongated lighting sources. The system is designed to be used as a framing molding or lighted trim for doors, windows, floors, ceilings and any other place where traditional wood or metal molding is used. The system is also utilizable as a mounting method for rope or module lighting that is meant to be decorative or utilitarian in nature, such as for lighting stairwells, signs, cubicles, and any other place where continuous rope and module lighting would be of aesthetic or useful nature (such as in fire emergencies).

The system of the present invention comprises the following components:

1. Molding members, which comprise strips of extruded or formed material such as of metal or plastic having longitudinal channels adapted for holding rope or flat module lighting respectively. Preferably such molding members further comprise means for mounting on a substrate, for holding accessories, and for permitting of cooling. The molding members preferably have circular channel elements to hold rope lighting or optical fibers and flat slots to hold LED circuit board elements.

2. Clear or tinted plastic cover elements which can be placed, such as by a snap-in placement, over the channel elements or slots having the lighting elements therein. These covers can be used as guards for the lighting elements, as light diffusers, or as decorative pieces when no light is needed.

3. Optional aluminum or plastic trim which can snap in place into the light channels or slights when no lighting elements are in them. This trim is sturdier than the clear plastic trim and can be more securely held by spring clips and key locks.

4. Optional spring clips, also called Bell Springs which can slide into channels and slots in the molding and will allow a secure snap fit for the trim.

5. Optional key locks, which are pronged strips of metal and are used at either end of a length of molding to lock in an aluminum trim piece. The trim cannot be removed without removing this lock.

6. Optional shoe members which are end pieces designed to be used at the bottom of the molding when the molding is used in a doorway. The shoe is hollow and can be used to hide the electrical cord for the rope light. It also has a breakaway wall on the side so molding with rope light can attach to it from the side.

7. Optional shoe bracket which comprises a bent sheet metal piece which gets attached to the wall or mounting surface first and then the shoe attaches to it.

8. Optional plinth element which is the same as the shoe, as a hollow molded piece, but is designed to act as the joint between two pieces of molding which are at 90 degrees to each other.

9. Optional plinth bracket corresponding to the shoe bracket, which is first attached to a wall and then the plinth is attached thereto.

Installation of the light framing system on a basic doorway preferably follows the following procedure:

Step 1. The molding is attached to the wall around the doorway with screws. The screws extend through the center rope-light channel with a space left between the floor and the end of the molding sufficient for installation of the shoes. Plinths are installed at the top corners of the frame.

Step 2. The shoe brackets and plinth brackets are screwed to the wall at the corners of the doorway as described.

Step 3. The rope lighting (for example) is inserted into the molding by snaking it thru the appropriate channels in the molding while making sure that the end of the rope light with the power cord is near an electrical outlet for a power source.

Step 4. Bell Springs are inserted into any unused light rope channels to maintain configuration integrity;

Step 5. Trim pieces are snapped into the Bell Springs;

Step 6. The Trim is locked in place with key locks at either end of the molding;

Step 7. Light diffusers are optionally snapped in over the light rope or other illumination member;

Step 8. The Plinths and Shoes are positioned over their respective brackets and secured from the sides by using screws which pass thru the Plinth or Shoe and into the bracket.

Alternatively the following assembly method allows quick assembly and disassembly with advantages as follows:

Alternate Mountinq Methods

The Molding can be mounting in other ways than the one listed above. One alternate method is to use the slots in the back side of the molding to hold a nut or bolt. This allows mounting the molding from the rear and also allows it to be hung like a drop-ceiling.

The Molding can also be mounted from its ends. Two grooves allow use of self tapping screws to be threaded in from the ends.

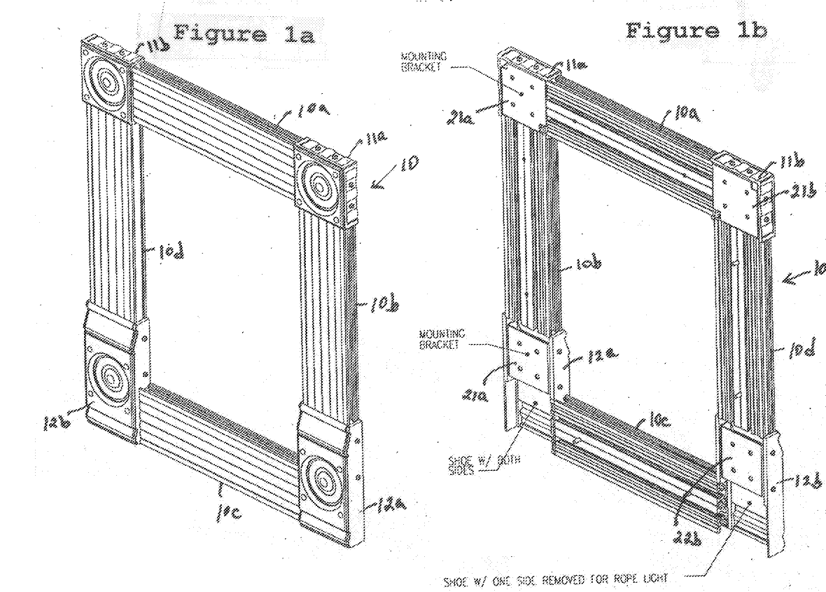

With specific reference to the drawings In FIGS. 1a and 1b lighting frame 10 is comprised of molding channels 10a-c which are connected at the lower corners by shoes 12a and 12b and at the upper corners by plinths 11a and 11b. The shoes and plinths are provided with decorative elements which may also be illuminated. The shoes 12a and 12b are held in position by respective mounting brackets 22a and 22b respectively, which are used to mount the frame around a door and the like. Mounting brackets 21a and 21b are the corresponding parts for plinths 11a and 11b.

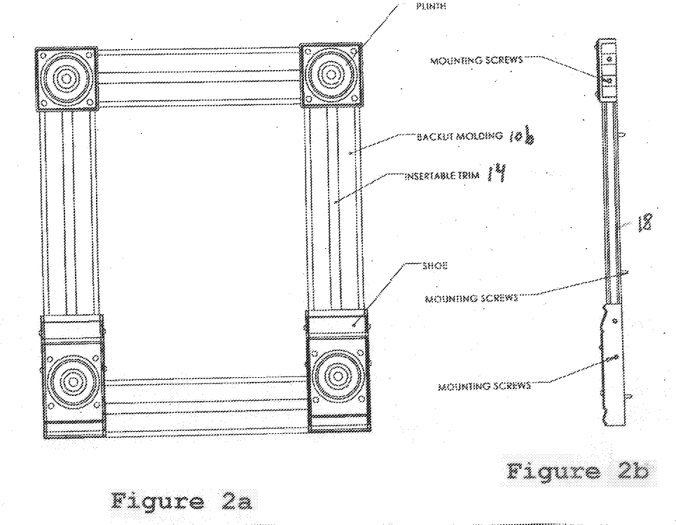

FIG. 2a shows the positioning of insertable trim 14 and FIG. 2b shows the frame as having a minimal thickness and flat surface suitable for attached placement on a wall.

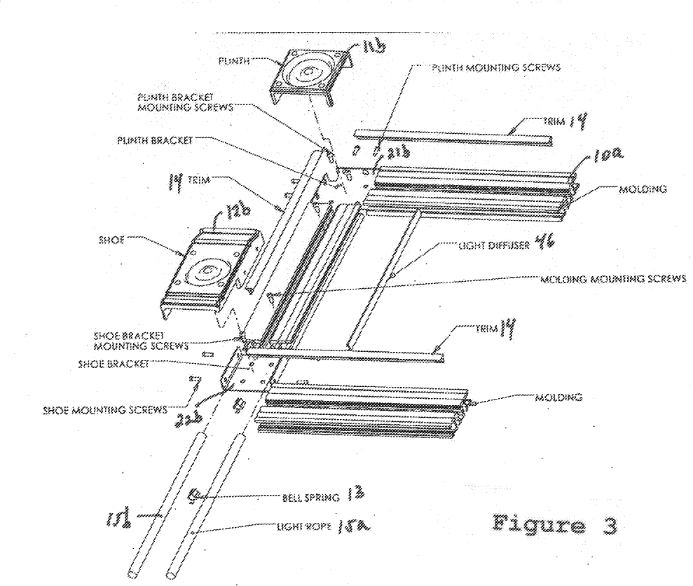

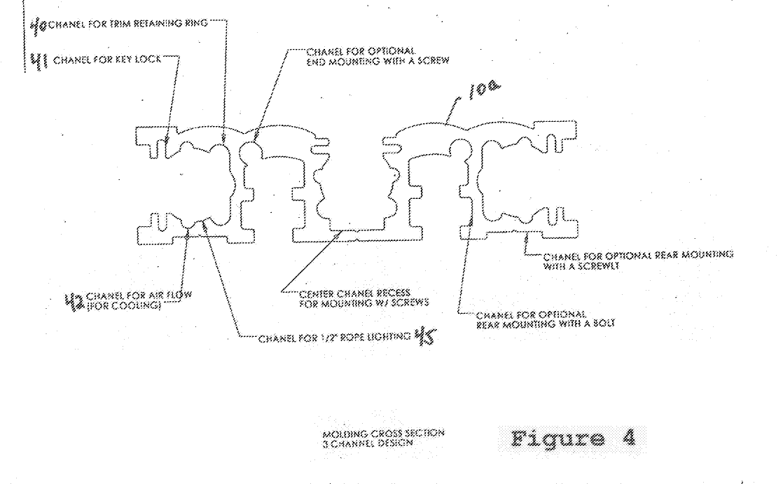

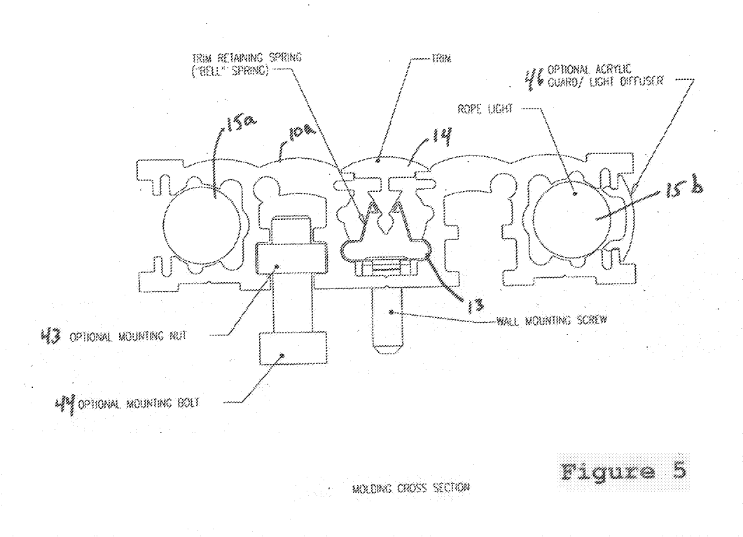

FIG. 3 depicts the internal components of the lighted frame with the light ropes 15a and 15b being inserted into the molding channel 45 (more clearly seen in FIGS. 4 and 5). Bell spring 13 is placed within the respective moldings as more clearly seen in FIG. 5. Positioning of trim 14 and light diffuser is further shown (more clearly seen in FIG. 5).

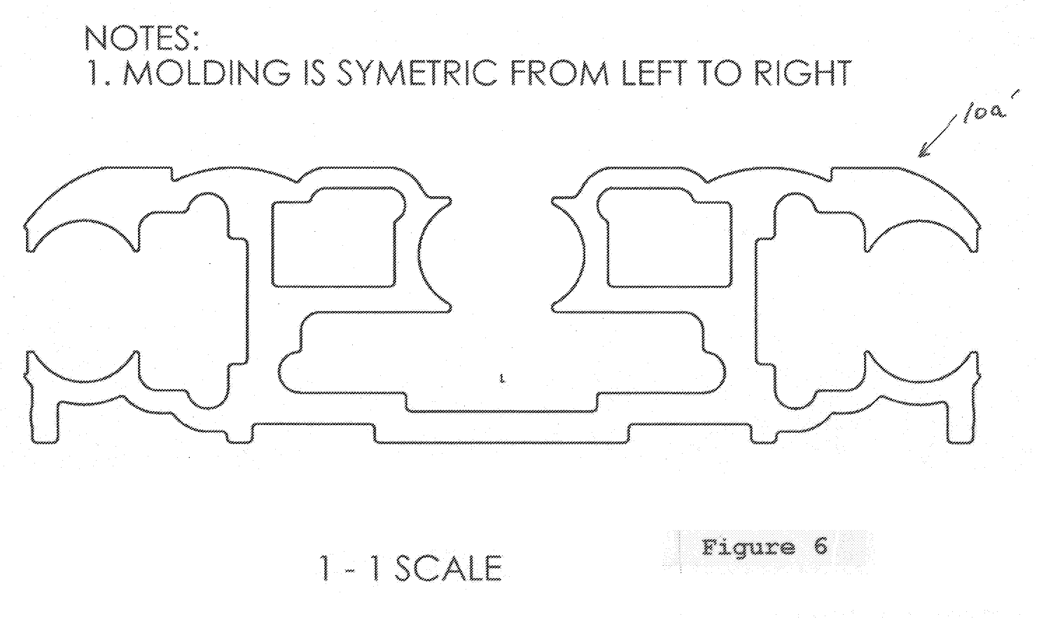

The molding 10a, shown in cross section in FIGS. 4 and 5 (and alternative structure in FIG. 6) contains various channels for various purposes. Channels 45 retain the rope lights 15a and 15b. Channel 42 provides cooling ventilation lighting members. Channel 41 accommodates a key lock for prevention of trim removal with the trim being held by a trim retaining ring within channel 40.

It is understood that the above exemplified embodiment and the drawings are representative of one possible version of the present invention The external cosmetic design of the molding, the number of light rope channels and the exact location of the mounting grooves are merely illustrative and changes for example in structure and design may be made without departing from the scope of the invention as defined in the following claims.

What is claimed is:

1. A backlit molding assembly for containment and positioning a lighting member, said molding comprising molding elements with said molding elements comprising channel means for the retention of the lighting member and whereby said molding assembly is adapted to be affixed to a substrate with said lighting member being positioned between the molding assembly and the substrate and wherein the frame element comprises means for permitting light from the lighting member to be visible therethrough as backlighting.

2. The backlight molding assembly wherein the lighting member is one or more of a rope light, and LED circuit board member or a fiber optic fiber.

3. The backlight molding assembly of claim 1, wherein the molding assembly is configuring in a framing shape which surrounds a door or a window.
